(19) United States
(12) Patent Application Publication
(10) Pub. No.: US 2008/0108237 A1
(43) Pub. Date: May 8, 2008

(54) Ball grid array socket having a positioning device

(75) Inventor: Hao-Yun Ma, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/982,963

(22) Filed: Nov. 6, 2007

(30) Foreign Application Priority Data
Nov. 6, 2006 (TW) 95219530

(51) Int. Cl. H01R 13/15; H01R 13/40

(52) U.S. Cl. 439/162; 439/733.1

(57) ABSTRACT

An electrical connector (2) comprises an insulative housing (4) and a number of metal plates (3). The insulative housing (4) has a bottom floor (45) and a number of side walls (46) extending perpendicularly from the bottom floor (45). The bottom floor (45) and the side walls (46) define a cavity (44) and an opening opposite the bottom floor (45) so that a chipset (8) could be loaded into the cavity (44) through the opening. Each of the metal plates (3) comprises a base portion (30) fixing the metal plate (3) to the insulative housing (4), a spring arm (31) extending from the base portion (30) and a pressing pad (32) connecting the spring arm (31) for flexibly abutting a side of the chipset (8).

### BACKGROUND OF THE INVENTION

1. Field of the Invention

The present invention relates to an electrical connector, and more particularly, relates to an electrical connector having a device for positioning an electrical element received in the electrical connector.

2. Description of the Prior Art

An electrical connector 9 related to present invention is disclosed in FIG. 1. The electrical connector 9 includes an insulative housing 10 and a grid array of conductive contacts 110 received in the insulative housing 10. The insulative housing 10 forms a base portion 13 and four side walls 12 to define a cavity 15 for receiving a chipset 8. Adjacent two of the side walls 12 respectively form spring arms 120, 120′ for flexibly abutting the chipset 8 against the corresponding side walls 12. However, the insulative housing 10 is difficult to be integrally injection-molded. Furthermore, the spring arms 120, 120′ are integrally made from polymer, so, when the chipset 8 is loaded and unloaded in more circles, the spring arms 120 may become tired or even broken from the side walls 12 so that the chipset 8 can not be positioned in the right place in the cavity 15.

### BRIEF SUMMARY OF THE INVENTION

Therefore, one object of the present invention is to provide a electrical connector having durable positioning device.

An electrical connector according to the present invention comprises an insulative housing having a bottom floor and a plurality of side walls extending perpendicularly from the bottom floor, the bottom floor and the side walls defining a cavity and an opening opposite the bottom floor so that an electrical element could be uploaded into the cavity through the opening; a metal plate, the metal plate comprising a base portion fixing the metal plate to the insulative housing, a spring arm extending from the base portion and a pressing pad connecting the spring arm for flexibly abutting a side of the electrical element.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of an electrical connector related to the present invention;

FIG. 2 is an explosive view of an electrical connector according to a first embodiment of the present invention;

FIG. 3 is a perspective view of a metal plate shown in FIG. 1;

FIG. 4 is a perspective view of the electrical connector shown in FIG. 2, with a chipset received therein;

FIG. 5 is a perspective view of a metal plate according to a second embodiment of the present invention;

FIG. 6 is a perspective view of a metal plate according to a third embodiment of the present invention; and

FIG. 7 is a perspective view of a metal plate according to a fourth embodiment of the present invention.

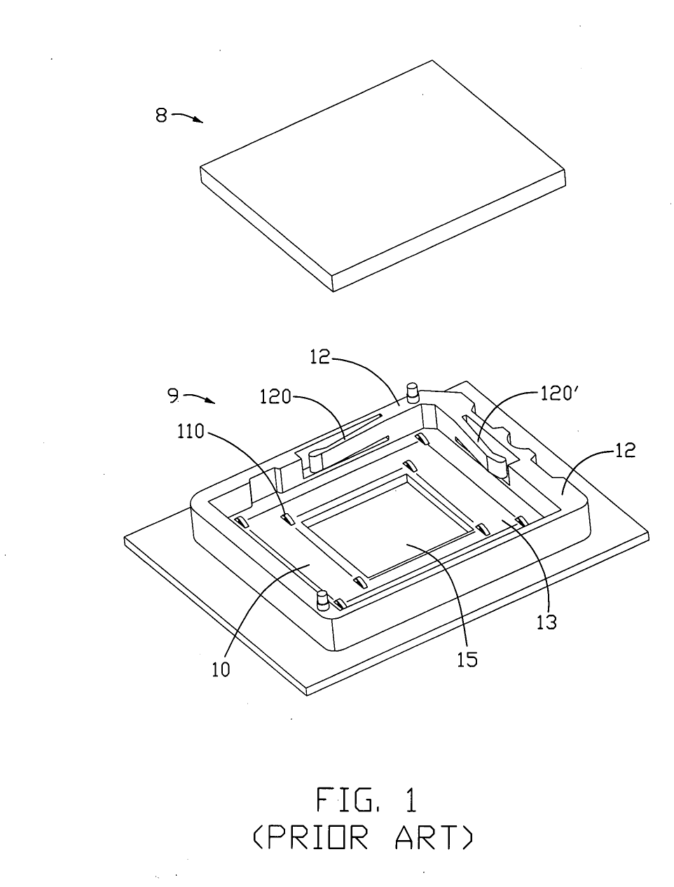

### DETAILED DESCRIPTION OF THE INVENTION

Reference will now be made to the drawing figures to describe the present invention in detail.

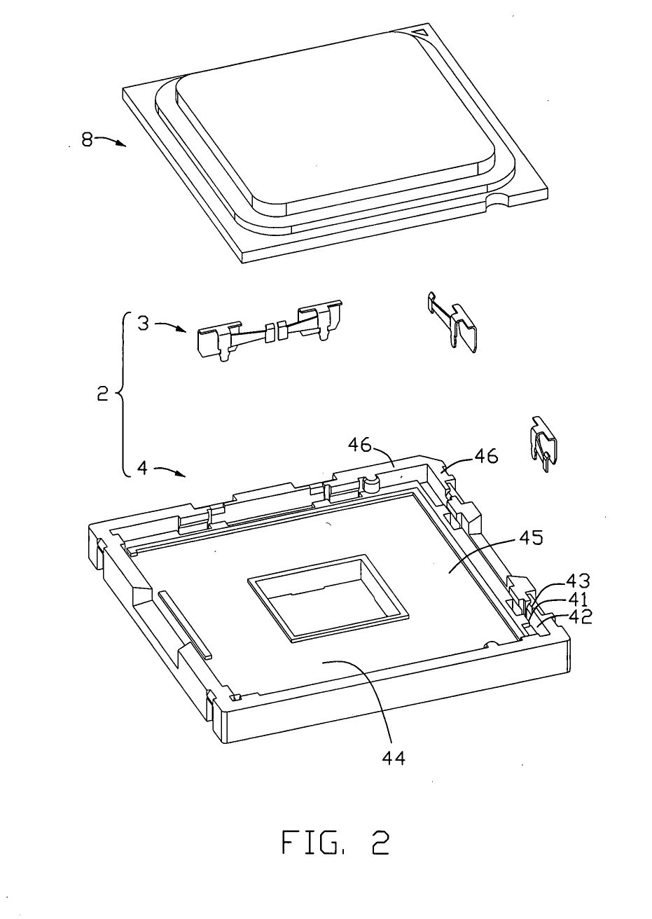

As shown in FIG. 2, the electrical connector of the present invention is used for connecting a chipset 8 to a printed circuit board (not shown). The electrical connector 2 includes an insulative housing 4 and four metal plates 3.

The insulative housing 20 forms a bottom floor 45 and four side walls 46 defining a cavity 44 and a opening opposite to the bottom floor 45. Adjacent two of the side walls 46 define sunken portions 42, 43 for receiving the metal plates. The bottom floor 45 defines securing holes 41 for interferentially mating with the metal plates 3.

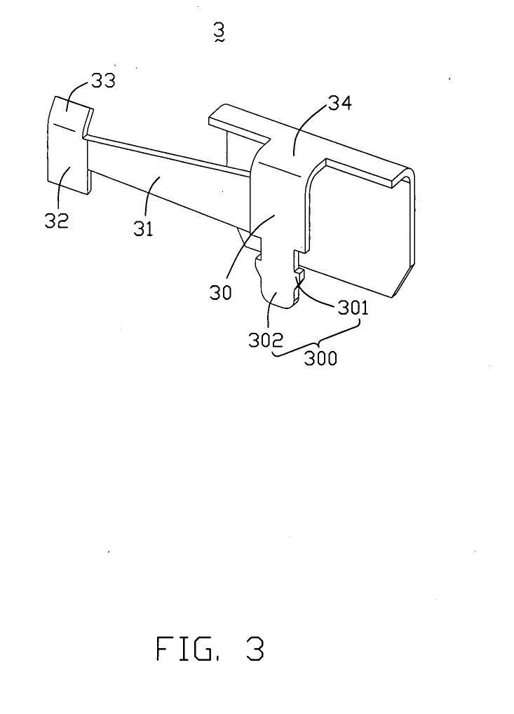

As shown in FIG. 3, each of the metal plates 30 comprises a base portion 30, a spring arm 31 extending from the base portion 30, a pressing pad 32 connected to a tip end of the spring arm 31 and a guiding portion 33. The base portion 30 further includes a U-shaped clipping portion 34 and a securing portion 300 having a tab 302 and stubs 301.

Since the fatigue strength of the metal is much high than the polymer, so the durability of the metal plate 3 for positioning the chipset 8 in the electrical connector 2 is much better than that of the spring arms 120, 120′ of the electrical connector 9. Furthermore, the spring arms 31 are not injection-molded integrally with the insulative housing 4, which makes the insulative housing 4 easy to be injection-molded.

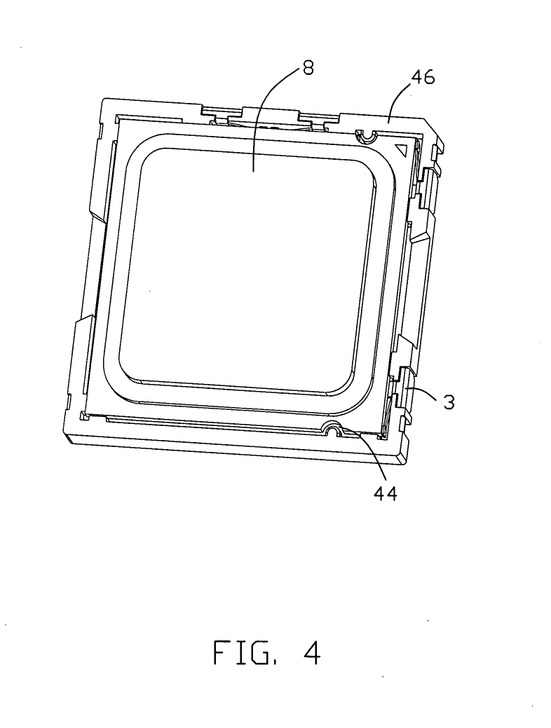

Referring to FIG. 5, a metal plate 5 forms a base portion 50, a straight spring arm 51 and a pressing pad 52. The base portion 50 further includes a supporting board 54 connecting the spring arm 51 and a securing portion 500 straightly extending from an edge of the supporting board 54.

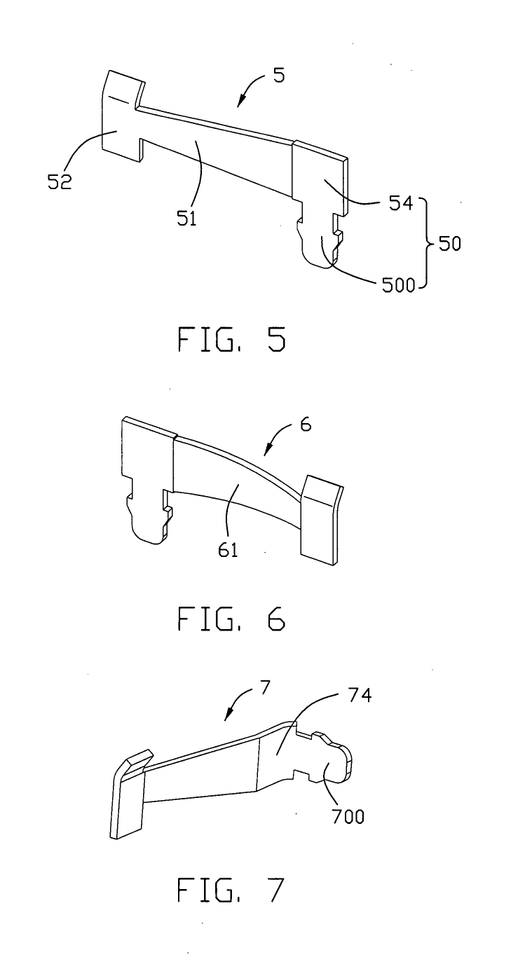

Referring to FIG. 6, a metal plate 6 according to a third embodiment is similar to the metal plate 5 except that an actuate spring arm 61 substitutes for the straight spring arm 51.

Referring to FIG. 7, a metal plate 7 according to a fourth embodiment is similar to the metal plate 5 except that a securing portion 700 is perpendicularly bent from a supporting board 74.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

We claim:

1. An electrical connector comprising:
an insulative housing having a bottom floor and a plurality of side walls extending perpendicularly from the bottom floor, the bottom floor and the side walls defining a cavity and an opening opposite the bottom floor for receiving an electrical element; and
a metal plate comprising a base portion fixed to the insulative housing, a spring arm extending from the base portion and a pressing pad connecting the spring arm for flexibly abutting a side of the electrical element.

2. The electrical connector according to claim 1, wherein the insulative housing has four side walls disposed in a rectangle and there are four metal plates mounted in adjacent two of the four side walls.

3. The electrical connector according to claim 1, wherein the base portion of the metal plate comprises a securing portion interferentially mating into a hole defined in the insulative housing and a clipping portion having a pair of parallel boards for clipping a portion of the side walls.

4. The electrical connector according to claim 1, wherein the base portion of the metal plate includes a securing portion interferentially mating into a hole defined in the bottom floor of the insulative housing and a supporting board parallely abutting one of the side walls.

5. The electrical connector according to claim 1, wherein the base portion of the metal plate includes a securing portion interferentially mating into a hole defined in one of the side walls of the insulative housing and a supporting board parallely abutting one of the side walls.

6. The electrical connector according to any one of claim 1, wherein the metal plate comprises a spring arm extending slant wisely from the base portion with respect to a corresponding side wall into the cavity.

7. The electrical connector according to claim 1, wherein the metal plate further comprises a guiding portion connector to the pressing pad.

8. The electrical connector according to claim 6, wherein the securing portion comprises a tab portion and a plurality of stubs extending sidewise from the tab portion.

9. An electrical connector assembly comprising:
an insulative housing having a plurality of side walls and a bottom wall commonly defining a receiving cavity therein;
an electronic package received in said receiving cavity;
at least one side wall defining an interior face intimately confronting a side edge of the electronic package;
a recess formed beside said abutment interior face and offset from said interior face in an outward direction; and
a discrete metallic piece located in said recess and defining a spring arm abutting against said side edge and imposing a force thereon.

10. The connector assembly as claimed in claim 9, wherein the metallic piece further includes a pressing pad abutting against the side edge, and said pressing pad defines an upward leading section.

11. The connector assembly as claimed in claim 9, wherein the metallic piece includes a secured to the housing on an interior side of the side wall.

12. The connector assembly as claimed in claim 11, wherein said metallic piece further includes a plate located on an exterior side of the side wall.

13. An electrical connector for receiving an electronic package, comprising:
an insulative housing having a plurality of side walls and a bottom wall commonly defining a receiving cavity therein;
at least one side wall defining an interior face for intimately confronting a side edge of the electronic package;
a recess formed beside said abutment interior face and offset from said interior face in an outward direction; and
a discrete metallic piece located in said recess and defining a spring arm abutting against said side edge and imposing a force thereon.

14. The connector assembly as claimed in claim 13, wherein the metallic piece further includes a pressing pad abutting against the side edge, and said pressing pad defines an upward leading section.

15. The connector assembly as claimed in claim 14, wherein the metallic piece includes a secured to the housing on an interior side of the side wall.

16. The connector assembly as claimed in claim 15, wherein said metallic piece further includes a plate located on an exterior side of the side wall.
